(19) United States
(12) Patent Application Publication
(10) Pub. No.: US 2015/0185007 A1
(43) Pub. Date: Jul. 2, 2015

(54) FREE-FLOATING DEVICE AND SYSTEM FOR THE DIRECTIONAL CHARACTERIZATION OF SURFACE WAVES

(71) Applicant: UNIVERSIDAD POLITÉCNICA DE MADRID, Madrid (ES)

(72) Inventors: Dana MacKay Deshetler Brinton, Madrid (ES); Raul García Cruz, Madrid (ES); Gabriel Navarro Almendros, Madrid (ES); Javier Tomás Ruiz Segura, Madrid (ES)

(21) Appl. No.: 14/407,853

(22) PCT Filed: Jun. 11, 2013
(86) PCT No.: PCT/ES2013/070376

§ 371 Date: Dec. 12, 2014

(30) Foreign Application Priority Data
Jun. 12, 2012 (ES) P201230916

(51) Int. Cl. G01C 13/00; B63B 22/00; G01V 3/08

(52) U.S. Cl. CPC G01C 13/002; G01V 3/08; B63B 22/00; B63B 2022/006

(57) ABSTRACT

The present embodiments relate generally to a free-floating device for the directional characterization of waves, comprising a selection of the following elements: sensors that can measure the earth's acceleration, angular velocity and magnetic field along three orthogonal axes, a GNSS tracker, an electronic module, a telecommunications module, energy capture and/or storage elements, a floating watertight container for housing the aforementioned equipment, having an optimized geometry so as to follow the slope of the surface of a water mass disturbed by waves. In addition, the information from the sensors and the GNSS tracker is managed by the electronic module and sent by the telecommunications module to a remote base station. Since the device is not anchored, it can characterize the direction of the surface waves more precisely, with improved operability and in a more economically efficient manner than current systems.

### CROSS-REFERENCE TO RELATED APPLICATIONS

This application is a U.S. National-Stage entry under 35 U.S.C. §371 based on International Application No. PCT/ES2013/070376 filed Jun. 11, 2013, and which claims priority to Spanish Application No. P201230916, filed Jun. 12, 2012, which are all incorporated herein by reference in their entirety.

### TECHNICAL FIELD

The technical field relates generally to a free-floating device for the directional characterization of waves that follows the slope of the surface of a water mass disturbed by waves, and secondly to a system for the directional characterization of waves that uses at least one free-floating device and a base station for the management of the system by a user. Note that throughout this document, the term “free-floating device” implies that the device is not anchored, fixed or attached to any structure, thereby floating freely in a water mass. The device described in the present embodiment comprises a selection of the following elements: a floating watertight container having an optimised geometry so as to follow the slope of the surface, a global positioning system (GNSS) to track the device, and a telecommunications module for sending and receiving communications with a base station and inertial sensors based on MEMS technology (Micro Electro Mechanical Systems) to generate a new device for the directional characterization of a surface wave, which is not anchored or fixed to any other structure. The device employs a management and operation procedure that allows the remote use of one or more of such devices. Compared with current existing systems, this combination of elements permits a more accurate measurement of the waves at a lower cost and with an easier operation in areas very far from or near the shore.

The technical field falls within that of the administration and private entities interested in incorporating the directional characteristics of waves in their operations for maritime climate analysis, wave assimilation into operational ocean or atmospheric models, marine forecasting and maritime safety warnings. Such entities include port authorities or meteorological agencies, those in need to know the wave conditions for the design of coastal structures and even those involved in military operations in which operability and safety depend on the waves.

### BACKGROUND

The recently filed United States patent application (Teng, US2011/0060525) SYSTEM FOR MONITORING, DETERMINING, AND REPORTING DIRECTIONAL SPECTRA OF OCEAN SURFACE WAVES IN NEAR REAL-TIME FROM A MOORED BUOY includes a comprehensive review of existing systems for the characterization of waves. Briefly, the patents that exist today exclusively measure wave height (Hue, U.S. Pat. No. 4,515,013; Luscombe, U.S. Pat. No. 4,986,121; Harigae, U.S. Pat. No. 6,847,326; Yamagishi, Japanese Patent Application 6,014,9911) or period (Yamaguchi, Japanese Patent Application 2005,083,998) but not its directionality. Besides these limitations, these patents or patent applications have the constraint (except Harigae's) of comprising designs relying on the anchoring to the seabed of the platform that integrates the wave measurement system. Teng's application describes a design that characterizes and transmits to land not only wave height and period but also provides a detailed description of the directional spectrum of surface waves in the sea. Said application also includes the incorporation of MEMS inertial sensors for the wave description.

The principle of operation of Teng's patent application is based, as in the present application, on a system with a geometry optimized to follow the slope of the surface of a water mass as it is disturbed by the waves. However, as the title of Teng's application denotes, the whole system is based on a buoy anchored to the seabed instead of on a free-floating buoy as described herein. This feature is common to other older patent documents, which in addition to proposing the measurement of the wave direction with non-MEMS technologies, have always considered that the device must operate anchored to the seabed. This is the case of the patent documents by Yung (FR 2275777 and FR 2355294), Erdely (FR2475747) and Brainard (U.S. Pat. No. 4,158,306).

The concept that the only possible way for a wave buoy to operate requires anchoring to the seabed persists even in non-patent literature. This is the case of manufacturers that have managed to reduce the size of the measurement devices but who unequivocally specify in their commercial information that buoys are designed to be attached to the seabed. This is so in the commercial information provided by manufacturers of models such as Seawatch Mini-Buoy® of Oceanor©, MK® of Envirtech©, Wadibuoy® of CNEXO-Nereides©, WaveScan® of Seawatch©, the Emerald Ocean Engineering© buoy or the Norwave® prototype. The models Triaxis® of the Axys Technology© company or Wave-Track® of Endeco© suggest in their respective commercial information that these buoys may potentially work without being fixed to the seabed. However, these buoys operate by the principle of characterizing the wave direction through a geometry which, instead of following the slope of the surface as proposed in this embodiment, follows the particles as they move within the waves. The principle of following the slope of the water mass surface as it is disturbed by waves (known as ‘slope-following’), which this embodiment is based on, is more accurate and less sensitive to manufacturing and operational defects than systems for the directional characterization of waves that are designed to follow particles as they move inside the waves (′particle-following′). Non-patent literature mentions free-floating directional systems based on the particle-following principle (L R LeBlanc and F H Middleton, Pitch-Roll Buoy Wave Directional Spectra Analysis; Defense Technical Information Center; published in 1982 in collaboration with Rhode Island University of Kingston). D. E. Marshall et al. (A Sonobuoy-Sized Expendable Air-Deployable Directional Wave Sensor, Pages 302-315, Ocean Wave Measurement and Analysis, published in 1997), describe a prototype with an optimized geometry for air launching but not optimized to use any of the two principles (slope-following or particle-following), which results, as admitted in their own description, in low accuracy measurements. In addition, these designs are not optimized to keep running when the device capsizes, a common inconvenient of devices based on the slope-following principle, which demands a flattened geometry in order to follow the surface of the waves with a minimum penetration therein.

The directional characterization of ocean waves using platforms anchored to the seabed or attached to other structures suffers from major drawbacks which are not present for a free-floating device. These drawbacks are particularly relevant in measurement systems based on the slope-following principle. The effect of the mooring line and wind on the important superstructures containing the buoy inhibits azimuth movement at certain wave frequencies (D E Marshall, National Data Buoy Centre Technical Document 96-01; Non-directional and Directional Wave Data Analysis Procedures, Neptune Sciences, Inc. 150 Cleveland Avenue, Slidell, La. 70458, published in 1996). These effects displace the cross-spectrum of wave elevation and slopes to angles that depend on the wave frequency. The correct characterization of the wave direction critically depends on such angles (D. E. Marshall, 1996), the determination of which is not trivial and which introduce uncertainty in the measurements performed by buoys anchored to the seabed.

The scientific literature mentions measurements performed by unmoored systems based on the slope-following principle (MS Longuet-Higgins et al., “Observations of the directional spectrum of sea waves using the motion of a floating buoy”; Ocean Wave Spectra pp 111-136, Prentice-Hall, New York; published in 1963, or the publication by R. H. Steward “A discus-hulled wave measuring buoy” Ocean Engng Vol 4, pp 101-107 published by Pergamon Press in 1974). These early attempts did not have continuity because nature, reliability and sensitivity of the sensors needed to characterize the directional spectrum of sea surface waves as well as their size and cost, as well as the complex calculations necessary to transmit to land a selection of parameters that characterize such spectrum, were simply inconceivable before the arrival of the digital age. The cost of accelerometers, gyroscopes and magnetometers, along with the computational power required for the processing of these signals and the electronics for the transmission to land made inconceivable its implementation in an unanchored float with a very high loss probability. Nevertheless, nowadays the telephone industry and robotics have converted this type of electronics and the MEMS-type inertial sensors into a very low-cost hardware, which allows the use of an unanchored device as a system that can be more economically efficient and provide a more accurate measurement with a higher spatial coverage than the moored buoys for the characterization of the wave direction in real-time. There already exist (off-the-shelf) inertial positioning systems generated for different industry sectors that combine sensors (accelerometers, gyroscopes and magnetometers, each of them in three orthogonal axes) at a very low cost but with a measurement frequency, sensitivity, robustness and reliability good enough such that, once installed within a float that is not attached to the seabed, they are able to monitor all the information needed for a complete directional characterization of waves in a wide spectrum frequency. Moreover, the new MEMS technology allows the implementation, as described in this embodiment, of systems that maintain the same functionality regardless of whether they operate in an upright or inverted position. This functionality, upright and inverted, was not feasible before the existence of MEMS technology. The revolutionary concept of integrating these extremely sophisticated inertial systems into free-floating devices whose recovery might be complicated due to their drift with the current, is the reason why embodiments gathering these characteristics have not been published or patented.

The drastic drop in the price of these systems in recent years, as well as that of global GNSS positioning systems and electronic telecommunications, makes it technically feasible and economically viable to use them in unanchored devices for the directional characterization of the wave that are based on the slope-following principle.

Furthermore, the present embodiment uses a particular embodiment of the float geometry that minimizes the risk of the device capsizing and the operational procedure of the system for the directional characterization of waves that are described in the Spanish patent application P201130980 “DISPOSITIVO PARA EL SEGUIMIENTO REMOTO DE MASAS DE AGUA Y PROCEDIMIENTO DE GESTIÓN Y OPERACIÓN REMOTO Y SIMULTÁNEO DE UN CONJUNTO DE DICHOS DISPOSITIVOS” (DEVICE FOR REMOTE TRACKING OF WATER MASSES AND METHOD FOR REMOTE AND SIMULTANEOUS MANAGEMENT AND OPERATION OF A SET OF SUCH DEVICES), which thus are not the object as such of the present embodiment.

### SUMMARY

The present embodiment consists in a free-floating device for the directional characterization of surface waves by using MEMS technology and the slope-following principle of the water mass when it is being disturbed by the waves. Such device is formed by a watertight float and the electronics contained therein. The watertight float can be of two types depending on whether it is aimed at minimizing the possibility of capsizing or allowing the device to keep full functionality regardless of whether it is inverted or not.

Its functionality includes a number of new features and advantages with respect to the state of the art by combining a selection of existing elements (MEMS inertial units, GNSS trackers, smart electronic controllers, telecommunications electronics, elements for energy capture and accumulation, floats, and management and operation procedures) in order to generate a new device which, operating unanchored, characterizes the directionality of surface waves in a more precise, operational and economically efficient manner than the current systems.

Thus, a first object of the embodiment is a free-floating device for the directional characterization of surface waves in a water mass. Such characterization is performed through the wave surface slope principle, this is, the device always follows the slope of the waves in their vertical displacements and in the zonal and meridional orientation of their inclination. The device comprises an external watertight float inside of which is contained the electronics of the device, with the electronics at least comprising:

at least one inertial sensor based on micro-electromechanical systems, with such sensor being a magnetometer to measure the Earth's magnetic field along three orthogonal axes;

one electronic module that acquires variables measured by the at least one sensor and that comprises means for calculating pitch, roll and orientation of the device relative to the north from the acquired variables and means for calculating the directional characterization of waves from the calculated pitch, roll and orientation relative to the north and which manages operational parameters of the at least one sensor, the operation of the device and energy storage means; and,

energy storage means that feed the electronics of the device.

In a particular embodiment, the device comprises additionally at least one inertial sensor based on micro-electromechanical systems selected from: an accelerometer that measures, along three orthogonal axes, the gravitational acceleration and an acceleration generated by the wave on the device; a gyroscope that measures, along three orthogonal axes, an angular velocity of the device; and, a combination of both.

In another particular embodiment, the watertight float has a geometry that ensures the non-inversion of the device without supplying an excessive righting torque that would hinder the inclination of the device while following the wave slope, and which comprises at least: a lower cylinder, open at its upper edge, to contain the energy storage modules; a first tronco-conical body with the smaller diameter end thereof being attached to the upper edge of the lower cylinder, comprising at least three concavities on the outer face thereof; a second tronco-conical body with the larger diameter end thereof being attached to the larger diameter end of the first tronco-conical body; a disc to attach the larger diameter end of the first tronco-conical shape with the free end of the cylindrical portion; and, a cylindrical element with an upper convex end and which is attached at its lower end to the smaller diameter end of the second tronco-conical shape, wherein the GNSS antenna and the telecommunication antenna are contained.

Furthermore, the larger diameter ends of the first and second tronco-conical bodies are attached by an interposed cylindrical body, with the larger diameter end of the second tronco-conical body having a greater diameter than the larger diameter end of the first tronco-conical body, said ends being attached by an annular body, and the walls of the cylindrical element being at least 50% longer than the largest diameter of the convex part, in order to keep the antennas apart from the buoy waterline.

In another particular embodiment, the watertight float includes elements at its lower part to provide additional stability to the float, said elements being selected from a ballast and a water anchor.

In another particular embodiment, the watertight float has a height/diameter ratio lower than one and a geometry that has a bilateral symmetry with respect to the waterline that is selected between a full symmetry and a symmetry sufficient to ensure an identical operation of the device in both the upright and inverted positions, an axial symmetry with respect to the central axis in the direction that defines the height, which is selected between a full symmetry and a symmetry sufficient to avoid the introduction of deviations in the measurement of the directional characterization of the wave and has a height/diameter ratio lower than one. The electronics of the device are placed in the central area of the float in order to maximize the buoyancy of the float periphery and minimize the rotational inertia with respect to axes parallel to the surface of the water mass.

In another particular embodiment, the device, regardless of the float geometry, includes a GNSS positioning tracker that determines the position of the device at any time.

In another particular embodiment, regardless of the float geometry, the device includes a telecommunications module, managed by the electronic module, which comprises means for two-way communication between the device and a base station and means for the remote management and operation of the device.

In another particular embodiment, when the float geometry ensures the identical operation of the device either in its upright position or in an inverted position, the GNSS position tracker comprises an antenna selected between an omnidirectional antenna oriented towards one of the sides of the device and an antenna oriented towards each of the emerged and submerged faces of the device, which ensures the reception of GNSS data if the device is either in its upright or inverted position.

In another particular embodiment, when the float geometry ensures the identical operation of the device in both an upright and inverted position, the device includes an antenna selected between an omnidirectional antenna oriented towards one of the sides of the device and an antenna oriented towards each of the emerged and submerged faces of the device, with the antenna being connected to the telecommunication module and that ensures a two-way communication between the device and the base station when the device is in upright or inverted position.

In another particular embodiment, when the geometry of the watertight float ensures the device not to capsize, such float includes capturing elements for solar energy capture that are located in the emerged part of the device, with the capturing elements being connected to the energy storage modules.

In another particular embodiment, when the float geometry ensures the identical operation of the device in both an upright and inverted position, the float includes capturing elements for solar energy capture that are located on the emerged and submerged faces of the device in order to capture solar energy in both the upright and inverted positions, with the capturing elements being connected to the energy storage modules.

In another particular embodiment, when the float geometry ensures the identical operation of the device in both the upright and inverted positions, the watertight float has a geometry selected among:

a cylinder with a height at its central part being selected from greater than, smaller than or equal to the height at the periphery thereof;

an ellipsoid with a height at its central part being selected from greater than, smaller than or equal to the height at the periphery thereof;

at least one concentric ring with any cross-sectional shape; and,

at least one axis with any cross-sectional shape extending radially from the center of the device.

In another particular embodiment, the electronic module comprises means for digitally processing the information gathered by the sensors and the GNSS module in order to convert it in parameters that characterize directionally the wave in the geographic location where the device is located. Furthermore, in another embodiment, the electronic module comprises means selected from encryption and decryption means, compression and decompression means and a combination of both, of the parameters that characterize directionally the wave to protect and minimize the information exchanged between the telecommunications module and the base station. The base station shall in turn include the corresponding encryption and decryption means, the compression and decompression means and a combination of both, in each case.

A second object of the present embodiment is a system for the directional characterization of surface waves in a water mass. Such system uses the free-floating devices described above and comprises at least one free-floating device for the directional characterization of surface waves and a base station for remote management and operation. In a particular embodiment of the system, the base station for remote management and operation comprises: at least one computer with Internet access and wireless communication means with the at least one device for the directional characterization of waves; storage information means; a user interface for at least one local operator and at least one electronic device to send and receive notifications from at least one remote operator; and, means for establishing hierarchies of priorities that assign priority levels to a set of basic information units that are exchanged between the at least one device and the base station.

During the device operation, the MEMS inertial sensors and the GNSS tracker monitor the movements of the device while it is following the changes in elevation and slope of the sea surface caused by the waves. Thus, the monitoring of the device performed by the sensors and tracker reflects the directional characteristics of the wave, which, hence, are recorded to be transmitted in real-time or downloaded by the user afterwards. The management and operation process of these devices allows the possibility of a remote and simultaneous operation of at least one device.

The use of a free-floating and unanchored device offers numerous advantages with respect to anchored devices belonging to the state of the art. Some of these advantages are the following:

The free-floating device performs a more accurate measurement of the wave directionality compared to devices attached to platforms.

The implementation and operation costs of the free-floating device are lower than those associated to devices attached to platforms.

The free-floating device allows a measurement of wave directionality in areas that are not operational for moored or anchored devices due to their proximity to or distance from the coast or due to their depth.

The free-floating device allows obtaining a broader record of the wave frequency band than devices attached to platforms.

### BRIEF DESCRIPTION OF THE DRAWINGS

FIG. 1 shows an elevation view of an example of an embodiment of the device of the present embodiment that follows the elevation and slope of the surface of a wave. In this case, the float geometry used minimizes the likelihood that the device will capsize.

FIG. 2 shows an elevation view of another example of an embodiment of the device of the present embodiment that follows the elevation and slope of the surface of a wave. In this case, the float geometry used maintains the functionality of the device even if it is inverted.

FIG. 3 shows an example of the inversion of the device shown in FIG. 2 caused by a wave. Because of the bilateral symmetry with respect to the waterline of both the float geometry and the electronics contained within, there is no difference in the device functionality before and after the inversion.

FIG. 4 shows a blocks diagram of the electronic components contained in a device in which all the modules and elements described in the text have been included.

FIG. 5. Example of an embodiment of the remote operation of the characterization system object of the present embodiment in a marine region far away from the coast.

FIG. 6. Example of an embodiment of the remote operation of the characterization system object of the present embodiment in a marine region close to the coast.

### DETAILED DESCRIPTION

The following detailed description is merely exemplary in nature and is not intended to limit the present disclosure or the application and uses of the present disclosure. Furthermore, there is no intention to be bound by any theory presented in the preceding background or the following detailed description.

Below, a description of several embodiments performed, with an illustrative and non-limiting nature, and making reference to the numbering adopted in the FIGS.

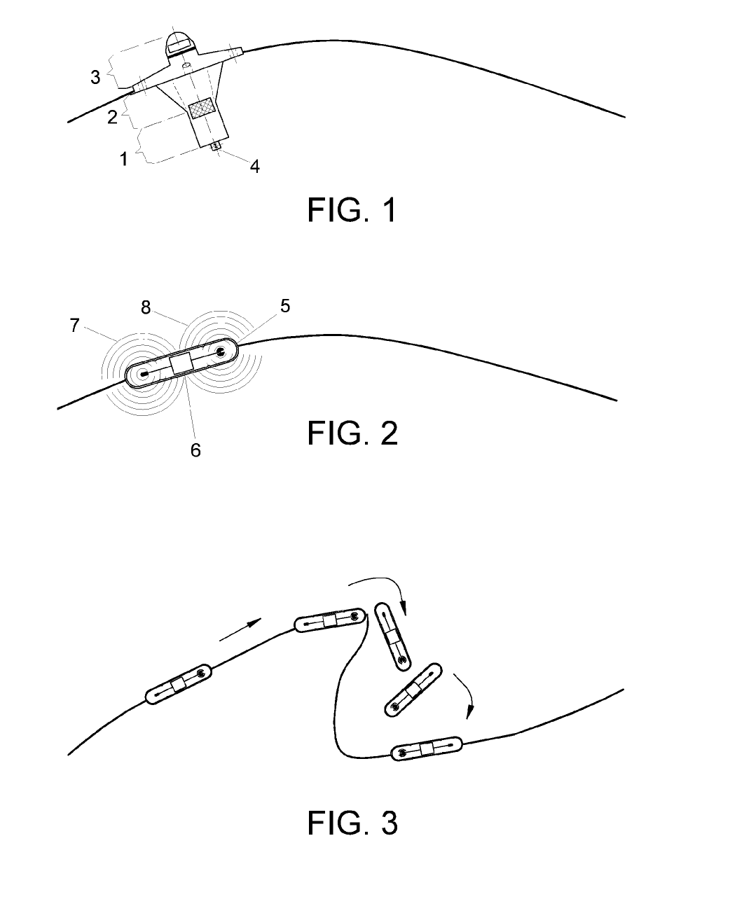

FIG. 1 shows the first of the geometries considered. The geometric design of the float has been already described in the Spanish Patent Application P201130980 entitled, “DEVICE FOR THE REMOTE TRACKING OF WATER MASSES AND METHOD FOR REMOTE AND SIMULTANEOUS MANAGEMENT AND OPERATION OF A SET OF SUCH DEVICES”. This geometry incorporates electronics and energy storage batteries in a lower hollow space (1). This design allows keeping the center of gravity of the device below the waterline, thereby preventing its inversion during operation at the sea. Moreover, this geometry allows stabilizing the device by placing heavy elements in the lowest part of (1) without requiring the submerged portion of the device to be large. This will force the inclination of the device to be according to the slope-following principle and not a mixture of the slope-following principle and the particle-following principle. The position of the centers of gravity and buoyancy of the device is optimized to avoid its inversion without the righting torque being excessively high and hampering the device to heel following the inclination of the sea surface caused by the waves. The float includes another inverted tronco-conical shape and a floating disc (2) that provide buoyancy, the size and shape thereof being optimized for the device to follow the movement of the wave surface during both the vertical displacements and inclination of said waves. This geometry allows combining the requirements of buoyancy and that the device must not capsize in order to continue its operation with that of maintaining a disc shape in the waterline. The disc shape is optimal under the slope-following principle, compared to others such as that of a spherical buoy, for the movement of a float (elevation and slope) to resemble that of the sea surface due to the presence of waves. Moreover, compared to other shapes such as a sphere, the float design shown in FIG. 1 provides a minimum emerged surface (3). This reduction in the emerged surface minimizes the inclination that the wind speed can cause on the device. In this way, deviations brought about by the wind on the device's role of monitoring the wave movements in elevation and slope are reduced. The emerged component is required to incorporate the GNSS antenna and the telecommunications antenna that are contained in the device. The float design includes components for anchoring elements in its lower part (4). These elements include, but are not limited to, the possibility of incorporating in the device a ballast or a water anchor to provide additional stability. Likewise, the emerged superstructure of this float may be adapted to incorporate elements for the capture of environmental energy. In particular, for extracting wave energy, these elements may be internally coupled to the float; in the case of other energy sources, such as solar, these elements can be attached externally through the geometry specified in P201130980 or through slight modifications thereof.

FIG. 2 shows the second of the geometries considered, which implements a design in which the device maintains full functionality regardless of whether it is in an upright or inverted position. In this geometry, the float (5) has an axial symmetry with respect to the central axis in the direction defining its height and a bilateral symmetry in relation to the waterline. The float has a height/diameter ratio lower than one. In this way, the submerged surface is minimized whereas the device operation is maximized for the principle of following the wave slope rather than that of following the particles of the waves. Also, the fact that the ratio is lower than one minimizes the wind exposure of the emerged surface. In this design, the full mass of the electronic components (6) is positioned centrally. This also leads to maximizing the buoyancy at the periphery of the float. Accumulation of buoyancy at the periphery increases the vertical force moment with respect to the center of the device generated by deviations in the orientation of the equatorial plane thereof with respect to the water surface. Similarly, by accumulating mass in the center, the rotational inertia with respect to rotation about axes parallel to the waterline is minimized. Both effects, the increase in the force moment associated to the buoyancy and the decrease in the rotational inertia, cause the device to react quickly and faithfully follow the elevation and slope of the water mass surface when it is disturbed by the waves. As is the case in catamarans, this geometry is very stable for not capsizing, but once it has turned over, it is equally stable in the inverted position. Therefore, the design must ensure operation under both upright and inverted positions. Incorporating three-axis MEMS sensors ensures this functionality with regard to the monitoring of pitch, roll or orientation with respect to north of the device. The accelerometer can detect if the device is upright or inverted and operate accordingly in order to provide, regardless of whether the device is upright or inverted, the zonal and meridional slope from data of pitch, roll and orientation with respect to the north of the device. By using three-axis MEMS sensors, there is no functional difference with the device in the upright or inverted positions.

When the device includes a GNSS tracker, GNSS data reception is guaranteed by incorporating two antennas (each facing one of the device faces) or an omnidirectional antenna. When the device is operated to transmit real-time wave data, communications must also be ensured. The same principle as that for the GNSS is then followed and either two antennas facing up and down or an omnidirectional antenna is included. In FIG. 2 the operation of both possibilities is exemplified, with an omnidirectional antenna (7) and with two antennas (8). For GNSS and telecommunications the device can use combinations of two double antennas, two omni-directional antennas or one omnidirectional antenna and a double antenna (shown as an example in FIG. 2). By combining a float geometry with axial and bilateral symmetry with the three-axis MEMS sensors and an antenna system as the one described above, all the possible operative functionalities of the device are maintained, regardless of whether it is upright or inverted. It is worth noting that in this way, one of the most frequently cited drawbacks of devices based on the slope-following principle is solved: the disc-shape that is required for floats that perform this kind of measurements is very likely to capsize by the wave action. The arrangement described above allows that the capsizing of the device does not to represent a problem but a natural way of operation.

As shown in FIG. 3, there is no difference in the device functionality if it is capsized by a wave. There is no difference in operation, in the directional characterization of the wave, in GNSS positioning, or in telecommunications, regardless of whether the device is upright or inverted with respect to the sea surface. For applications requiring environmental energy capture, elements that capture wave energy can be placed within the float or solar panels can be placed on both faces of the device. The design shown in the FIG. is disc-shaped with a perfect axial symmetry. The design would be equally effective in implementing the slope-following principle if deviations in the axial symmetry occur (for example with ellipses-shaped or polygons-shaped layouts) that are not large enough to compromise the dynamic response of the device during its function of following the wave slope. The design is also valid under deviations of the bilateral symmetry with respect to the waterline (because one of the sides is larger or has a different shape than the other), provided such deviations do not compromise the device functionality in the upright and inverted positions.

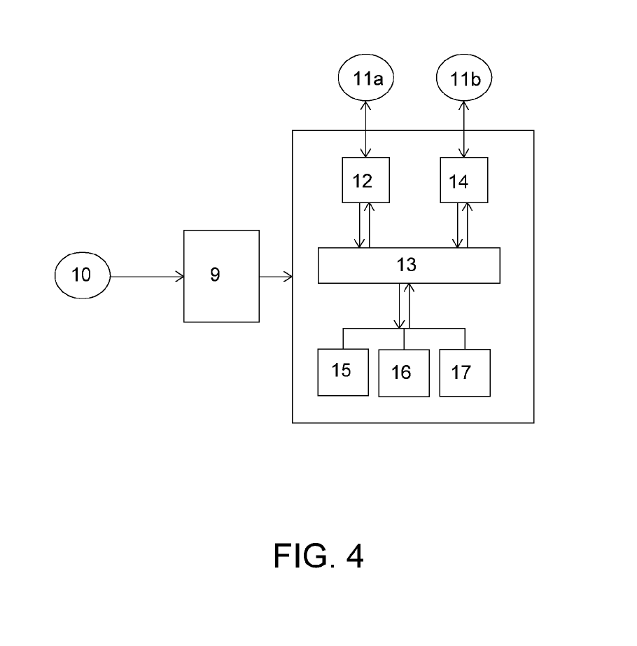

Any of the two float geometries contains a selection of the electronics elements required for the entire device to perform its function (FIG. 4). The energy reserve (9) can be connected to an energy generator (10). It may also contain antennas for the transmission and reception of electromagnetic waves that are necessary when it is desired to incorporate telecommunications and positioning functions in the device (11). If it is desired to incorporate the telecommunications function, the antenna/s are connected to the telecommunications module (12), which transmits and receives the basic information units required in the simultaneous and remote management and operation process. The telecommunications module has a two-way interaction with the electronic module (13). This electronic module (13) in turn interacts with the GNSS tracker (14) and the set of sensors (15, 16, 17) contained in the device and implements the various communication and operation protocols.

When it is desired to incorporate a GNSS location function, the GNSS tracker (14) allows knowing the latitude and longitude where the device is located at any time. Variations in longitude and latitude along with altitude measurements provided by the GNSS may be used by the electronic module (13) for its procedures for the directional characterization of a wave. Sensors (15, 16, 17) have a two-way interaction with the electronic module (13), which in turn controls the sensors. The measurement interval and sampling frequency of sensors are controlled by the electronic module (13) where data are also stored. These sensors may include, but are not limited to, a three-axis accelerometer (15), which is able to measure the gravitational acceleration or that caused by the wave on the entire device along three orthogonal axes, a gyroscope (16) that is able to measure the angular velocity of the device during a rotation about three orthogonal axes and a magnetometer (17) that is able to measure the Earth's magnetic field along three orthogonal axes. All these sensors are based on micro-electromechanical systems (MEMS) having a very low cost and sufficient reliability, accuracy, sensitivity and sampling frequency to monitor the directional characteristics of surface waves.

The electronic module (13) controls the whole operation of the internal electronics of the device. The functions performed by this electronic module include but are not limited to the following:

Obtaining the position from the data obtained by the GNSS tracker when this functionality is incorporated.

Obtaining the values of the variables measured by the sensors. In order to obtain these values the electronic module must be able to calibrate each sensor, change the sampling frequency of each sensor, change the recording time of the data generated by the sensors, and control the quality of the measurements of these sensors and make decisions in case any of them presents malfunctions.

The measurement intervals and frequency necessary for determining the directional regime of the wave can make unfeasible the transmission of raw information through the telecommunications module (12). Transmission costs may be particularly high and the energy consumption excessive. The electronic module (13) may, in these cases, be responsible for carrying out the mathematical processing of the raw data collected by the sensors (accelerometer (15), gyroscope (16), magnetometer (17) and GNSS (14)), for the device to send only the parameters necessary for the directional characterization of the wave. These parameters may include, but are not limited to, time series of the wave elevation or the vertical acceleration of the wave as well as its slope with respect the north and east, the significant wave height (Hₘₒ), the average period (T_{zero}), or the direction ((or the direction, the Tₚₑₐₖ) of the waves and its spectral characteristics, such as the non-directional spectral density of each frequency (C₁₁), coefficients of the cross-spectrum of height and inclinations in both its cos-spectrum component (Cᵢⱼ) or the quadrature spectrum (Qᵢⱼ) for each frequency, or directional Fourier coefficients for each frequency. They may also include, but are not limited to, the maximum and minimum values and the standard deviation of the records of pitch, roll and full tilt of the device, its orientation relative to the Earth's magnetic field and their spinning speeds during the measurement interval. The determination of the elements necessary for obtaining these parameters from the sensors included in the device is performed by public methods and algorithms. The electronic module collects data produced by the sensors and converts them in the parameters to be transmitted by the telecommunications module (12), including a possible encoding aimed at saving energy and costs in telecommunications.

Implementing the process of remote management and operation with the base station for remote management and operation and with remote operators when the device incorporates the telecommunications functionality. Through this procedure, the electronic module can send and receive basic information units with the rest of the system elements. Among the basic information units, consultation and confirmation of available device, periodic parameters, configuration parameters, critical events or other events may be considered.

When the device incorporates the telecommunications functionality, carrying out measurements and communication operations simultaneously by allocating the necessary resources to each operation in such a way that none of the two phases alters the functioning of the other.

Managing power consumption by all modules by turning them on only during the time periods in which they are needed and switch them to a low power mode during periods where no activity is required.

On the other hand, when the device incorporates the telecommunications functionality, the remote and simultaneous management and operation procedure of a set of free-floating devices for the remote and directional characterization in real-time of surface waves operates identically to the simultaneous and remote management and operation procedures of a set of devices to track water masses described in the Spanish patent application P201130980, except some extensions aimed at accommodating new functions added in the new device for the characterization of surface waves.

This procedure for remote management and operation involves the exchange of information related to certain wave characteristics (characteristics determined by sensors incorporated in the float) and uses a number of elements involved in the procedure: at least one, in this case, free-floating device for the directional characterization of surface waves, a hierarchy of previously established priorities (designated from P1 to P3) that are assigned to basic information units and the basic information units (named from U1 to U8) with the priorities allocation (P1 to P3). Likewise, the procedure provides the flow of such basic information units between the different elements involved, i.e. the set of free-floating devices and the base station.

The hierarchy of priorities of the information exchanged between such elements includes the three following levels of priority:

P1: information that has to be exchanged between two of the elements previously described and whose reception must be guaranteed in real time.

P2: information transmitted between two of the elements previously described, whose reception must be guaranteed although a lapse of time between the emission and reception of the information is allowed.

P3: information transmitted by one of the previous elements in which the reception by another of these elements may not be guaranteed, but the sender must be aware of its reception or not, in order to be able to decide about its subsequent re-transmission.

The basic information units that are exchanged in the described procedure are the following:

U1: If a device is accessible or not by the operation center

U2: Request for the set of parameters recorded by any of the devices

U3: Response to a type U2 request, containing the set of parameters recorded by such device

U4: Set of parameters recorded by the devices that are periodically delivered to the center for remote management and operation, according to a cadence previously established by the local operator of the center

U5: Requests for changes in the configuration of the tracking devices

U6: Confirmation or not of a change in the configuration by the devices

The procedure identifies some special basic information units generated in the devices, the so-called events, which respond to the detection of a change in the functioning status and that can affect their operation and/or represent a major shift in their operation and/or in the generated information. They are the only information units that may be optionally forwarded to the additional set of operators and/or supervisors. According to their priority, they can be divided into two groups:

U7: Critical events generated in the devices that report changes in their status or functioning, which are of great relevance for the management and operation of the devices in which they were generated

U8: Other events generated in the devices that report changes in their status or functioning which are important to be known by the local operator to perform an efficient operation and management.

Note that the management procedure of the elements comprised in the system for characterization of surface waves object of the present embodiment, is envisaged to be, in a particular embodiment, the method described in Spanish patent application P201130980, with the information transmitted by the devices that follow the water mass corresponding to that obtained from the characterization of such surface wave. However, other system management methods not mentioned in this document would be perfectly valid.

Due to differences between the internal electronics of the present embodiment and the embodiment described in the Spanish patent application P201130980, the following additions to the procedure have been taken into account for the particular embodiments mentioned above:

Extending the parameters requested by the center for remote management and operation (base station in the present embodiment) to include the variables generated by the GNSS tracker, temperature inside the free-floating device, power level of the device, time series of the wave elevation or of the vertical acceleration of the wave as well as the wave slope with respect to the north and east, dominant direction (ominant direction (well asment Tₚₑₐₖ) of the wave, significant height (Hₘₒ), average wave period (T_{zero}), non-directional spectral density of each frequency of the wave (C₁₁), coefficients of the cross-spectrum of height and inclinations in its cos-spectrum components for each frequency (Cᵢⱼ), coefficients of the cross-spectrum of height and inclinations in its spectrum components in quadrature for each frequency (Qᵢⱼ), directional Fourier coefficients for each frequency, maximum, minimum and average values and standard deviation of the pitch of the device during the integration time, maximum, minimum and average values and standard deviation of the roll of the device during the integration time, maximum, minimum and average values and standard deviation of the inclination of the device during the integration time, maximum, minimum and average values and standard deviation of the orientation with respect to the Earth's magnetic field during the integration time, and a combination thereof.

Extending the parameters sent periodically by at least one device described in the patent application P201130980 to include the variables generated by the GNSS tracker, temperature inside the surface wave device, power level of the device, time series of the wave elevation or of the vertical acceleration of the wave as well as the wave slope with respect to the north and east, dominant direction (ominant direction (ation of the Tₚₑₐₖ) of the wave, significant height (Hₘₒ), average wave period (T_{zero}), non-directional spectral density of each frequency of the wave (C₁₁), coefficients of the cross-spectrum of height and inclinations in its cos-spectrum component for each frequency (Cᵢⱼ), coefficients of the cross-spectrum of height and inclinations in its spectrum components in quadrature for each frequency (Qᵢⱼ), directional Fourier coefficients for each frequency, maximum, minimum and average values and standard deviation of the pitch of the device during the integration time, maximum, minimum and average values and standard deviation of the roll of the device during the integration time, maximum, minimum and average values and standard deviation of the inclination of the device during the integration time, maximum, minimum and average values and standard deviation of the orientation with respect to the Earth's magnetic field during the integration time, and a combination thereof.

Extending the list of requests for changes in the device configuration described in the patent application P201130980 such that the request for device configuration comprises being a request selected from:

a. a request for a change in the configuration of the calibration values of the sensors that are required for the directional characterization of surface waves.
b. a request for a change in the configuration of a recording cadence of variables generated by the GNSS tracker;
c. a request for a change in the configuration of a recording cadence of the internal temperature of the device;
d. a request for a change in the configuration of a recording cadence of the variables generated by the sensors that are required for the directional characterization of surface waves;
e. a request for a change in the configuration of a recording cadence of intermediate variables required for the directional characterization of surface waves and which are obtained from the series of values registered by the sensors;
f. a request for a change in the configuration of a recording cadence of the wave elevation or of the vertical acceleration of the wave as well as the wave slope with respect to the north and east, dominant direction (ominant direction (ation of the Tₚₑₐₖ) of the wave, significant height (Hₘₒ), average wave period (T_{zero}), non-directional spectral density of each frequency of the wave (C₁₁), coefficients of the cross-spectrum of height and inclinations in its cos-spectrum components for each frequency (Cᵢⱼ), coefficients of the cross-spectrum of height and inclinations in its spectrum components in quadrature for each frequency (Qᵢⱼ), directional Fourier coefficients for each frequency, maximum, minimum and average values and standard deviation of the pitch of the device during the integration time, maximum, minimum and average values and standard deviation of the roll of the device during the integration time, maximum, minimum and average values and standard deviation of the inclination of the device during the integration time, and maximum, minimum and average values and standard deviation of the orientation with respect to the Earth's magnetic field during the integration time;
g. a request for a change in the configuration of a submission cadence of parameters that are sent periodically by at least one device, which require a lower mathematical processing selected between the variables generated by the GNSS tracker, temperature inside the device, a power level of the device, and a combination thereof;
h. a request for a change in the configuration of a submission cadence of parameters that are sent periodically by at least one device, which require a higher mathematical processing selected from the time series of the wave elevation or of the vertical acceleration of the wave as well as the wave slope with respect to the north and east, dominant direction (ominant direction (ration of the Tₚₑₐₖ) of the wave, significant height (Hₘₒ), average wave period (T_{zero}), non-directional spectral density of each frequency of the wave (C₁₁), coefficients of the cross-spectrum of height and inclinations in its cos-spectrum components for each frequency (Cᵢⱼ), coefficients of the cross-spectrum of height and inclinations in its spectrum components in quadrature for each frequency (Qᵢⱼ), directional Fourier coefficients for each frequency, maximum, minimum and average values and standard deviation of the pitch of the device during the integration time, maximum, minimum and average values and standard deviation of the roll of the device during the integration time, maximum, minimum and average values and standard deviation of the inclination of the device during the integration time, maximum, minimum and average values and standard deviation of the orientation with respect to the Earth's magnetic field during the integration time and a combination thereof;
i. a request for a change in the configuration of an average threshold of temperature inside the device;
j. a request for a change in the configuration of a closed boundary to limit a geographical area of interest when the device leaves the geographical area;
k. a request for a change in the configuration of a closed boundary to limit a geographical area of interest when the device entries into the geographical area; and,
l. a combination of the former requests.

Extending the list of requests for changes in the device configuration described in the patent application P201130980 such that the request of device configuration comprises being a request selected from:

a. a request for a change in the configuration of the calibration values of the sensors that are required for the directional characterization of surface waves.
b. a request for a change in the configuration of a recording cadence of variables generated by the GNSS tracker;
c. a request for a change in the configuration of a recording cadence of the internal temperature of the device;
d. a request for a change in the configuration of a recording cadence of the variables generated by the sensors that are required for the directional characterization of surface waves;
e. a request for a change in the configuration of a recording cadence of intermediate variables required for the directional characterization of surface waves and which are obtained from the series of values registered by the sensors;
f. a request for a change in the configuration of a recording cadence of time series of the wave elevation or of the vertical acceleration of the wave as well as the wave slope with respect to the north and east, dominant direction ( ) of the wave, dominant period (Tₚₑₐₖ) of the wave, significant height (Hₘₒ), average wave period (T_{zero}), non-directional spectral density of each frequency of the wave (C₁₁), coefficients of the cross-spectrum of height and inclinations in its cos-spectrum components for each frequency (Cᵢⱼ), coefficients of the cross-spectrum of height and inclinations in its spectrum components in quadrature for each frequency (Qᵢⱼ), directional Fourier coefficients for each frequency, maximum, minimum and average values and standard deviation of the pitch of the device during the integration time, maximum, minimum and average values and standard deviation of the roll of the device during the integration time, maximum, minimum and average values and standard deviation of the inclination of the device during the integration time, and maximum, minimum and average values and standard deviation of the orientation with respect to the Earth's magnetic field during the integration time;
g. a request for a change in the configuration of a submission cadence of parameters that are sent periodically by at least one device, which require a lower mathematical processing selected between the variables generated by the GNSS tracker, temperature inside the device, a power level of the device, and a combination thereof;
h. a request for a change in the configuration of a submission cadence of parameters that are sent periodically by at least one device, which require a higher mathematical processing selected between the time series of the wave elevation or of the vertical acceleration of the wave as well as the wave slope with respect to the north and east, dominant direction ( ) of the wave, dominant period (Tₚₑₐₖ) of the wave, significant height (Hₘₒ), average wave period (T_{zero}), non-directional spectral density of each frequency of the wave (C₁₁), coefficients of the cross-spectrum of height and inclinations in its cos-spectrum components for each frequency (Cᵢⱼ), coefficients of the cross-spectrum of height and inclinations in its spectrum components in quadrature for each frequency (Qᵢⱼ), directional Fourier coefficients for each frequency, maximum, minimum and average values and standard deviation of the pitch of the device during the integration time, maximum, minimum and average values and standard deviation of the roll of the device during the integration time, maximum, minimum and average values and standard deviation of the inclination of the device during the integration time, maximum, minimum and average values and standard deviation of the orientation with respect to the Earth's magnetic field during the integration time and a combination thereof;
i. a request for a change in the configuration of an average threshold of temperature inside the device;
j. a request for a change in the configuration of a closed boundary to limit a geographical area of interest when the device leaves the geographical area;
k. a request for a change in the configuration of a closed boundary to limit a geographical area of interest when the device entries into the geographical area; and,
l. a combination of the former requests.

The procedure may include previous compression and/or encryption of basic information units before being sent for their subsequent decompression and/or de-encryption after reception of said basic information units. This inclusion allows minimizing the size of said basic information units and/or maintaining their privacy. It can also include that the basic information units can be sent and received directly, or with previous compression by the emitter and subsequent decompression by the receiver, or with previous compression and encryption by the emitter and decompression and de-encryption by the receiver.

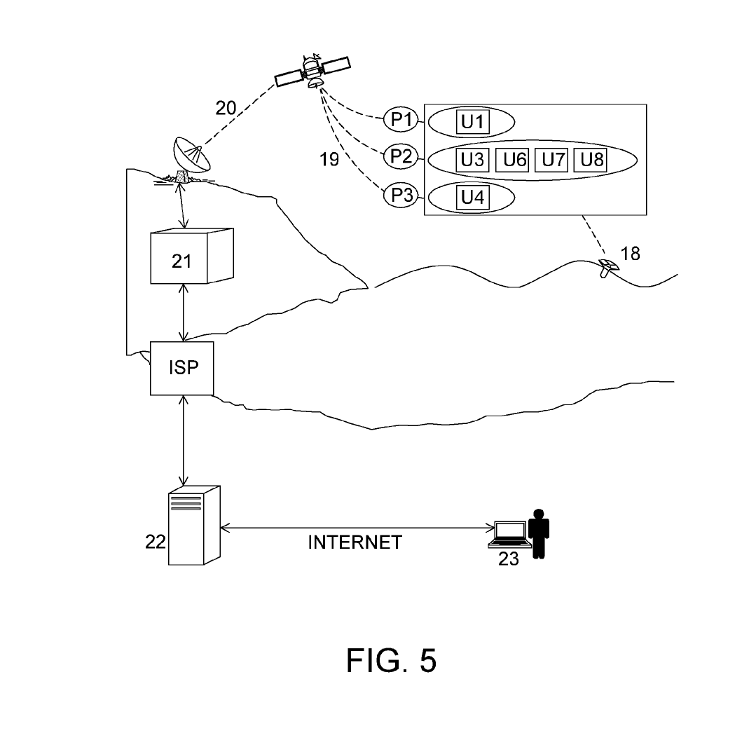

FIG. 5 shows a specific example of an embodiment in which free-floating devices for the directional characterization of the wave are implemented in a deep marine area far away from the coast, thereby being inoperative for the existing devices that are fixed to the seabed. In this example of embodiment the geometry that minimizes the possibility of inversion of the device is used. The floats (18) have incorporated solar panels. Incorporating solar panels allows the capture of energy in order to have a long operating life. The device integrates in an unanchored float with an appropriate geometry the electronics necessary for its operation, including telecommunications, control, power and measurement. As the area is very far from the coast, it can be more economic not to use an ad hoc boat to launch the devices, due to the massive associated costs. Instead, they can be thrown from vehicles not specialized in marine mooring operations, such as a plane. In other embodiments a passenger boat, ship freight or other pleasure crafts could be used. Once in the water, the GNSS tracker of each unit identifies its position and, together with the inertial sensors, monitors the waves. The electronic module processes this information to be transmitted together with other auxiliary information regarding the operation of the device. The telecommunications module transmits such information via satellite (19) as the distance from the coast prevents, for example, the use of the mobile phone network. In this example, the Iridium network is identified but other networks such as Globalstar or Orbcomm could be used in another embodiment or radio telecommunications of VHF, MF or HF frequencies could be considered in other. From the receiving antennas in land (20), such information is made available to a base station (21) and finally to a server (22) through the Internet via an Internet Service Provider (ISP), if applicable. This server can in turn send management and operation commands to the devices via the base station, antennas and satellites. This server or another computing element can continue processing the information in order to distribute it to agencies interested in the characteristics of the waves in the sea (23). Among them may be those responsible for providing weather forecasts as key elements in the maritime safety and accidents prevention. Telecommunications between devices and server are governed by a two-way protocol that allows the remote management of the whole system, the modification of the measurement characteristics of the sensors, and the reaction to events that may jeopardize the operation of the units. Note that the method used in the exchange of information between free-floating devices and base station corresponds to that described in the Spanish patent application P201130980 but with the previously mentioned modifications. These modifications, which are mainly requests for parameters requested by the base station, which parameters are periodically sent by the free-floating device and requests for changes in the configuration of the free-floating device, are type U4 basic information units (sets of parameters recorded by the devices that are sent periodically to the center for the remote management and operation, according to a cadence previously established by the local operator of the base station) with type P3 priority (information transmitted by the devices or the station, in which the reception by the other of such elements may not be guaranteed, but the sender must be aware of its reception or not, in order to be able to decide about its subsequent re-transmission). The basic information units U1 to U3 and U5 to U7 correspond to those described in the Spanish patent application P201130980.

In another example of embodiment, devices are implemented in a manner similar as that shown in FIG. 5 but in which the second geometry, which keeps full functionality in both the upright and inverted positions, is used. In order to do this, a float geometry similar to (5) instead of (18) is implemented by using a disc-shaped design with solar panels on both faces.

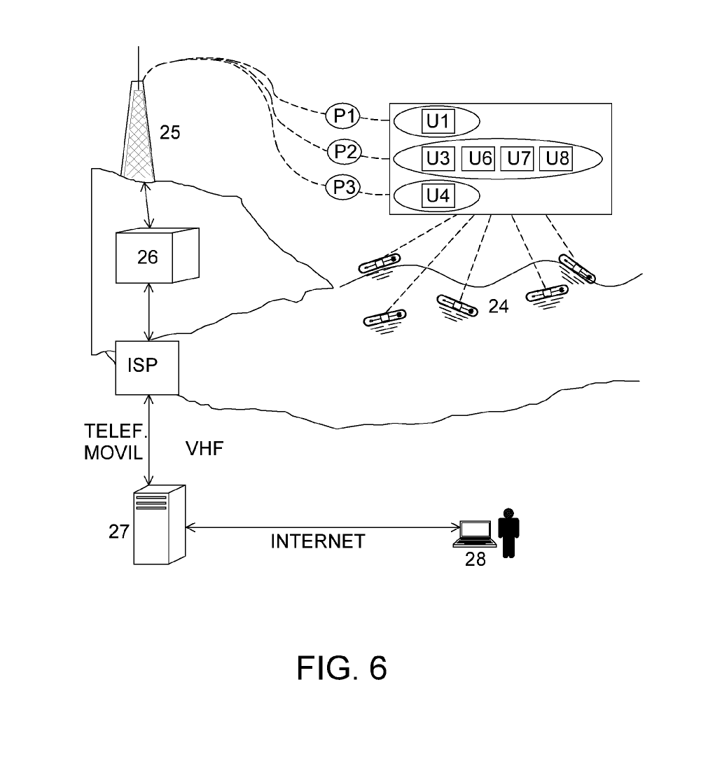

FIG. 6 illustrates another specific example of embodiment. In this case, it refers to an area close to the coast that allows the launching of the devices from a simple raft. The low cost and facility of embodiment allow obtaining information about the directional characteristics of the wave, with the spatial structure being solved through a network of devices (24). In this example of embodiment, a geometry that keeps its functionality both in upright and inverted position is used. The device monitors, processes and transmits directional characteristics of the wave via land antennas (25) for mobile phones or VHF. From the receiving antennas in land this information is made available to a base station (26) and finally to a server (27) via the Internet. This server can in turn send management and operation commands to the devices via the base station. This server or another computing element can continue processing the information to assist, for instance, the work planning of constructions in coastal engineering (28). The method used for the exchange of information between free-floating devices and the base station in this embodiment corresponds again to that described in Spanish patent application P201130980, although incorporating the previously mentioned modifications.

In another example of embodiment devices are implemented as shown in FIG. 6 but the first of the geometries is used, which minimizes the possibility of inversion of the device.

In another example of embodiment, devices with any the two possible geometries are implemented but telecommunications functionality is not incorporated. In this case, the device is operated for a certain time in the water mass, the electronic module stores records in an internal memory and, at the end of the operation, the device is picked up by an user to download information directly (through a USB port or wireless systems such as Wi-Fi or Bluetooth). In this case, the operator, besides downloading the information directly, must be able to locate easily the device at the end of sampling. This could be achieved by incorporating LED light signals and/or acoustic signals in the device. In another example of embodiment, the device lacks both the telecommunications functionality and the GNSS tracker.

In another example of embodiment, the information provided by a network of unanchored devices, as the one described in FIGS. 5 and 6, is used as a substitute of wave observation systems based on anchored devices that are operated routinely by countries with coastal domains for maritime safety, by using telecommunications via land antennas or satellite depending on their necessities or convenience.

The advantages of this embodiment over other systems for the directional characterization of the wave through the principle of the surface slope-following that exist today are derived from the use of the MEMS technology that is integrated in geometries optimized to run without the device to be anchored to the seabed or fixed to other structures. Existing systems for the directional measurement of the wave through the slope-following principle either do not use MEMS technology or are based on the concept that the device must be attached to the seabed or to other structures. The concept that the device must be fixed is understandable taking into account that until recently the inertial sensors, GPS trackers and telecommunications technology had a very high cost. Nevertheless, the drastic price drop experienced for these electronic components and their robustness have opened a new scenario that makes the proposed embodiment technically and economically feasible, and confers a number of important advantages over the existing technology. Some of these advantages are the following:

a. The directional characterization of the wave is more accurate as a result of three advantages of free-floating systems versus fixed devices. On one hand, fixed devices have a mooring line that is required to keep the system attached to the corresponding structure. This mooring line includes, among others, chains and elements of the ballast and/or coupling. Taken together, this line constitutes an element that interacts with the buoy motion and deviates the buoy from its function of following faithfully the sea surface when it is being altered in elevation and slope by the effect of waves. Furthermore, the wind action combined with the attachment results in a tendency to orient the moored buoys towards the wind (as in a weather-vane). This effect also introduces distortions in the function of the float to follow precisely the sea elevation and slope. Finally, the existence of marine currents causes an inclination of the fixed disc-shaped floats (needed to measure by using the principle of inclination) that is not originated by the waves, thus introducing artifacts in the directional characterization of the wave.
b. A free-floating device that works by using the slope-following principle can be designed to maintain full functionality in both upright and inverted positions (FIGS. 2 and 3). Thus, one of the major drawbacks that measuring equipment based on the slope-following principle have traditionally had is avoided: the possibility that the entire device turns over.
c. A free-floating device is cheaper than one designed to be anchored. The drastic price drop in MEMS inertial sensors means that these represent at present only a small fraction of the cost required for the directional characterization of the wave. The free-floating devices require neither complex and resistant floats nor expensive attachment items that are needed for the systems that are anchored to the seabed.
d. The overall operating costs are lower. The large reduction in costs resulting from the use of a free-floating device also implies that the maintenance costs of the systems anchored to the seabed or fixed to other structures are avoided. The free-floating device has a cost that makes it economically efficient to assume a strategy by which the device is released into the sea, where it will complete all its operation life, assuming that it will be finally lost and there will be no need for subsequent maintenance. Unlike systems that are anchored or attached to structures, this strategy eliminates the need to use a boat, with high associated costs, to access the device and perform maintenance operations. For example, in terms of ship time, a day of a boat equipped to carry out this kind of maintenance operations costs between thousands and tens of thousands of Euros, whereas the market price of MEMS is at present, tens of Euros.
e. As the free-floating device does not require attaching and maintenance, it can be implemented in areas that are not currently accessible by anchored systems. This circumstance occurs in central parts of the big oceans that demand in situ measurements to feed operational models for weather prediction and maritime security. These measurements are not operative through moored systems due to the enormous difficulties to set the measurement platform to a deep seabed and because the artifacts present in a long mooring line may alter the wave measurements. In addition, the boat costs for maintenance of the measurement stations located at several hundred nautical miles from the coast are prohibitive. All these inconvenient are absent in the free-floating measurement device presented in this patent. These remote areas of the ocean or others in which navigation is difficult, such as the Polar Regions, can be sown with this free-floating device, thus simplifying significantly the wave measurement in them.
f. The implementation costs of the unanchored device are reduced. Its small size and the robustness of the MEMS make feasible its launching from aircrafts or from commercial cargo or passenger ships, without the need to use a specifically designed ship with the capability to perform mooring and maintenance operations.
g. Their small size also makes feasible their use in areas very close to the coast where it is often necessary to determine the directional characteristics of the wave for engineering operations or prevention activities and where the use of anchored systems is not operational, due to the proximity to the coast. Also, because of their small size, raft type boats are big enough to transport a large number of these devices during very near shore operations.
h. The small size of these devices also allows increasing the wave frequency band characterized. Monitoring of the wave energy contained in the higher frequencies is limited by the physical dimensions of the equipment. As the unanchored devices have a smaller size compared to anchored structures, higher frequencies can be monitored.
i. The low cost of each free-floating device allows the possibility of sowing a particular ocean region with these devices. The controlling protocol permits managing the network of devices to perform a characterization of the wave with a higher spatial resolution than that given by fixed systems.
j. A free-floating device can also function as a Lagrangian tracer for the current, thereby being able to perform jointly the monitoring of currents and waves, a combination for which no commercial device is currently available.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the present disclosure in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the present disclosure as set forth in the appended claims and their legal equivalents.

1. A free-floating device for the directional characterization of the surface waves of a water mass, the directional characterization of waves being performed according to a wave surface slope-following principle, wherein the electronics of the device is contained in an external watertight float, the device comprising:
at least one inertial sensor for measuring the Earth's magnetic field along three orthogonal axes, the inertial sensor being a magnetometer;
an electronic module that acquires variables measured by the sensor for calculating pitch, roll and orientation of the device relative to north from the acquired variables;
energy storage means that feed the electronics of the device; and
means for calculating parameters for the directional characterization of waves from the calculated pitch, roll and orientation relative to north and which manages operational parameters of the at least one sensor, the operation of the device and the energy storage means.

2. The free-floating device of claim 1, further comprising at least one additional inertial sensor selected from the group comprising an accelerometer that measures along three orthogonal axes, the gravitational acceleration and an acceleration generated by the wave on the device; a gyroscope that measures along three orthogonal axes an angular velocity of the device; and a combination of both.

3. The free-floating device of claim 1, wherein the watertight float has a geometry, comprising:
a bilateral symmetry with respect to the waterline selected from a full symmetry and a symmetry sufficient to ensure an identical operation of the device in the upright and inverted positions;
an axial symmetry with respect to a central axis in a direction that defines the height, selected from a full symmetry and a symmetry sufficient to avoid the introduction of deviations in the measurement of the directional characterization of the waves; and
a height/diameter ratio lower than one,
the electronics of the device being placed in the central area of the float.

4. The free-floating device of claim 3, further comprising a GNSS positioning tracker that determines the position of the device.

5. The free-floating device of claim 4, wherein the GNSS positioning tracker comprises an omnidirectional antenna oriented towards one of the sides of the device or an antenna oriented towards each of the faces of the device which are symmetrical respective to the waterline.

6. The free-floating device of claim 3 further comprising a telecommunications module managed by the electronic module, which comprises two-way communication means between the device and a base station and means for the remote management and operation of the device.

7. The free-floating device of claim 6, further comprising an antenna selectable between an omnidirectional antenna oriented towards one of the sides of the device and an antenna oriented towards each of the faces of the device which are symmetrical respective to the waterline, the antenna being connected to the telecommunications module, in order to provide two-way communication between the device and the base station with the device in the upright and inverted positions.

8. The free-floating device of claim 3, further comprising solar energy capturing elements located in the faces of the device that are symmetrical with respect to the waterline, for capturing solar energy in the upright and inverted positions, with the solar energy capturing elements being connected to the energy storage means.

9. The free-floating device of claim 3, wherein the watertight float has a geometry selected from:
a cylinder with a height at the central part thereof being selected from greater than, smaller than or equal to the height at the periphery thereof;
an ellipsoid with a height at the central part thereof being selected from greater than, smaller than or equal to the height at the periphery thereof;
at least one concentric ring with any cross-sectional shape; and
wherein at least one axis with any cross-sectional shape extending radially from the center of the device.

10. The free-floating device of claim 1 wherein the watertight float has a geometry comprises:
a lower cylinder, open at its upper edge, the energy storage means;
a first tronco-conical body with the smaller diameter end thereof attached to the upper edge of the lower cylinder, comprising at least three concavities on the outer face thereof;
a second tronco-conical body having larger diameter end thereof attached to the larger diameter end of the first tronco-conical body;
a disc for attaching the larger diameter end of the first tronco-conical body with the free end of the cylindrical portion; and
a cylindrical element an upper convex end and which is attached at its lower end to the smaller diameter end of the second tronco-conical body;
the larger diameter ends of the first and second tronco-conical bodies being attached by an interposed cylindrical body, with the larger diameter end of the second tronco-conical body having a greater diameter than the larger diameter end of the first tronco-conical body, said ends being attached by an annular body, and the walls of the cylindrical element being at least 50% longer than the largest diameter of the convex part,
the geometry of the watertight float for ensuring the non-inversion of the device without supplying an excessive righting torque that would hinder the inclination of the device while following the wave slop.

11. The free-floating device to of claim 10, wherein the watertight float includes at the lower part thereof elements to provide additional stability to the float, the elements being selected from a ballast and a water anchor.

12. The free-floating device, of claim 10, further comprising: a GNSS positioning tracker that determines the position of the device.

13. The free-floating device of claim 10, further comprising: a telecommunications module managed by the electronic module, which comprises two-way communication means between the device and a base station and means for the remote management and operation of the device.

14. The free-floating device of claim 10, wherein the float includes solar energy capturing elements that are placed in the part of the device, with the capturing elements being connected to the energy storage means.

15. The free-floating device of claim 4, wherein the electronic module comprises means for digitally processing the information gathered by the sensors and the GNSS module in order to convert it into parameters that characterize directionally the waves in the geographic location where the device is located.

16. The free-floating device of claim 15, wherein the electronic module comprises means selected from means for encryption and decryption, means for compression and decompression, and a combination of both, of parameters that characterize directionally the waves to protect and minimize the information exchanged between the telecommunications module and the base station.

17. System for the directional characterization of surface waves in water masses comprising at least one free-floating device according to claim 1 and a base station for remote management and operation.

18. The system of claim 17, wherein the base station comprises:
at least one computer with Internet access and wireless communication means with the at least one device for the directional characterization of waves;
storage information means;
a user interface for at least one local operator;
at least one electronic device to send and receive notifications from at least one remote operator; and,
means for establishing hierarchies of priorities that assign priority levels to a set of basic information units that are exchanged between the at least one device and the base station.
